(19) United States
(12) Patent Application Publication
(10) Pub. No.: US 2004/0127165 A1
(43) Pub. Date: Jul. 1, 2004

(54) METHOD FOR CONTROLLING THE POWER OF RADIO FREQUENCY SIGNALS EMITTED BY A WIRELESS COMMUNICATIONS DEVICE

(76) Inventors: Ju-Nau Chang, Taipei Hsien (TW); Meng-Hua Kao, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,185

(22) Filed: Dec. 25, 2002

(51) Int. Cl. H04B 7/00

(52) U.S. Cl. 455/69; 455/522

(57) ABSTRACT

A method for controlling power levels of radio signals output by a wireless communications device is disclosed. The wireless communications device includes an RF transceiver. The method includes utilizing the RF transceiver of the wireless communications device to receive RF signals output by a wireless transmission device, and adjusting the power of RF signals output by the wireless communications device according to the power of the RF signals received by the wireless communications device.

### BACKGROUND OF INVENTION

1. Field of the Invention

The present invention relates to a method for controlling the power of radio frequency (RF) signals emitted by wireless communications device, and more particularly, to a method for adjusting the power of the RF signals emitted by the wireless communications device according the power of the RF signals emitted by a wireless transmission device and received by the wireless communications device.

2. Description of the Prior Art

During the past decade, the dramatic development of wireless communications technologies has brought out many kinds of wireless communications devices. Please refer to FIG. 1, which is a block diagram of a wireless communications system 10 according to the prior art. The wireless communications system 10 comprises an access point (AP) 12 and a plurality of wireless communications devices 14, 16, and 18. The wireless communications device 14 exchanges data with the wireless communications devices 16 and 18 through the AP 12. Each communications device 14, 16, or 18 has an RF transceiver 80 for emitting and for receiving the RF signals.

Please refer to FIG. 2, which is a function block diagram of the RF transceiver 80. The RF transceiver 80 comprises an antenna 20, a directional coupler 24 electrically connected to the antenna 20, an RF power detector 26 electrically connected to the directional coupler 24, a demodulator 28 electrically connected to the RF power detector 26, and a modulator 30 electrically connected to the directional coupler 24.

The antenna 20 of the transceiver 80 receives RF signals emitted by the AP 12 and emits RF signals generated by the wireless communications devices 14, 16, and 18. The directional coupler 24 comprises a control end 22 for receiving a control signal to switch the antenna 20 to electrically connect with the RF power detector 26 or with the modulator 30. The RF power detector 26 detects the power of the RF signals received by the antenna 20 and transmitted from the directional coupler 24. The RF power detector 26 then adjusts the power of the RF signals according to the power of the RF signals such that the RF signals the demodulator 28 receives has a moderate power. The demodulator 28 of the RF transceiver 80 transforms the RF signals, having a moderate power, into intermediate frequency (IF) signals with a demodulating and a band-pass filtering processes.

For example, when the power of the RF signals received by the antenna 20 is lower than a threshold (the wireless communications devices 14, 16, and 18 are far from the AP 12), after detecting that the power of the RF signals is lower than the threshold, the RF power detector 26 increases the power of the RF signals and then transmits the RF signals whose power has been raised to the demodulator 28. On the other hand, when the power of the RF signals received by the antenna 20 is higher than the threshold (the wireless communications devices 14, 16 and 18 are close to the AP 12), after detecting that the power of the RF signals is higher than the threshold, the RF power detector 26 decreases the power of the RF signals and then transmits the RF signals whose power has been reduced to the demodulator 28, preventing the demodulator 28 from receiving the unmodified high-powered RF signals. Too high of powered RF signals may damage the demodulator 28.

The modulator 30 of the RF transceiver 80 transforms IF signals into RF signals. The RF signals have a predetermined power. Then the wireless communications devices 14, 16, and 18 emit the RF signals with the antenna 20. Of course, at this moment, the directional coupler 24 is switched to electrically connect the antenna 20 to the modulator 30.

In the prior art wireless communications system 10, the RF signals emitted by the wireless communications devices 14, 16, or 18 still have the predetermined power, no matter what the distance between the wireless communications devices 14, 16, or 18 and the AP 12 is and how strong the RF signals emitted to the AP 12 need to be.

### SUMMARY OF INVENTION

It is therefore a primary objective of the claimed invention to provide a method for a wireless communications device to emit RF signals having a variable power level by determining the power of RF signals emitted by a wireless transmission device and received by the wireless communications device.

According to the claimed invention, the wireless communications device has an RF transceiver for emitting and for receiving the RF signals. The method includes using the transceiver of the wireless communications device to receive the RF signals emitted by a wireless transmission device, and adjusting the power of the RF signals emitted by the transceiver of the wireless communications device according to the power of the RF signals received by the wireless communications device.

According to the claimed invention, the transceiver includes an antenna for emitting and for receiving the RF signals, a directional coupler, a power detector for generating a power correction factor according to the power of the RF signals, a modulator for generating the RF signals, and a multiplier electrically connected between the power detector and the modulator for multiplying the RF signals generated by the modulator and the power correction factor generator by the power detector. When the transceiver is receiving the RF signals, the directional coupler is switched to connect the antenna to the power detector and the power detector generates a power correction factor according to the power of the RF signals received by the transceiver. When the transceiver is emitting the RF signals, the directional coupler is switched to connect the antenna to the multiplier, the multiplier multiplies the power correction factor and the RF signals generated by the modulator to generate RF signals of a corrected power, and the antenna emits the RF signals of the corrected power.

It is an advantage of the claimed invention that a method for the wireless communications device to emit RF signals can reduce the power consumption of the mobile phones 44, 46, and 48.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a wireless communications system according to the prior art.

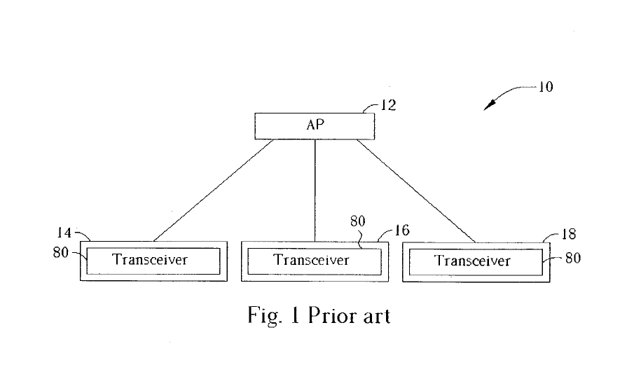

FIG. 2 is a function block diagram of an RF transceiver of a wireless communications device in the wireless communications system shown in FIG. 1.

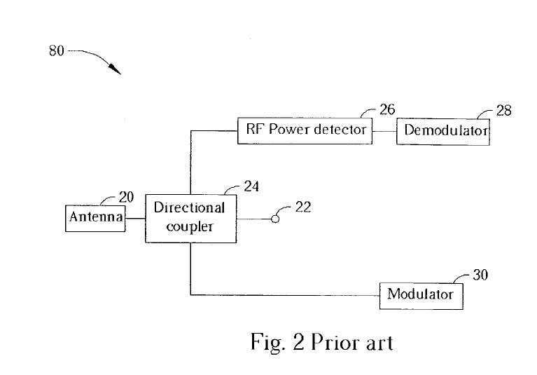

FIG. 3 is a block diagram of a wireless communications system according to the present invention.

FIG. 4 is a function block diagram of an RF transceiver of a wireless communications device in the wireless communications system shown in FIG. 3.

FIG. 5 is a flow chart illustrating a method for the communications devices shown in FIG. 3 to emit RF signals.

### DETAILED DESCRIPTION

Because the method of the present invention is applied to a wireless communications device, a preferred embodiment of the wireless communications device is hereby disclosed.

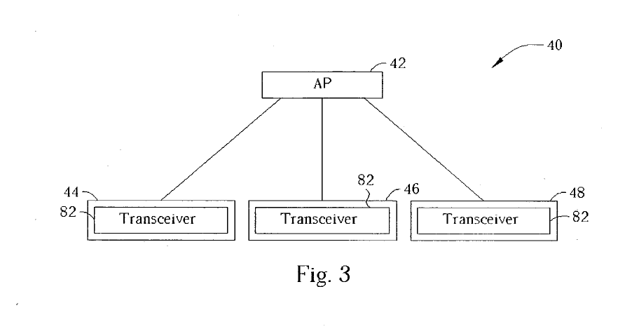

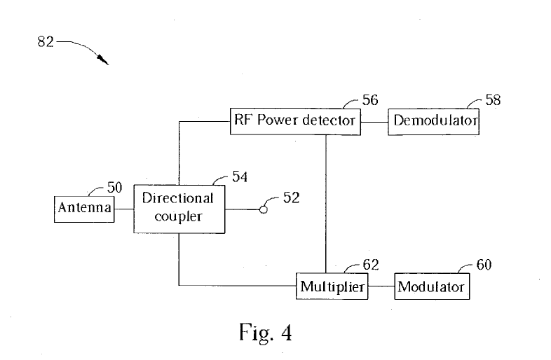

Please refer to FIG. 3 and FIG. 4. FIG. 3 is a block diagram of a wireless communications system 40 according to the present invention. The wireless communications system 40 comprises an AP 42 and a plurality of wireless communications devices 44, 46, and 48. Each wireless communications device 44, 46, and 48 comprises an RF transceiver 82. Each wireless communications devices 44, 46, or 48 can be a mobile phone or a personal data assistant (PDA).

FIG. 4 is a function block diagram of the RF transceiver 82 according to the present invention. The RF transceiver 82 comprises an antenna 50, a directional coupler 54 electrically connected to the antenna 50, an RF power detector 56 electrically connected to the directional coupler 54, a demodulator 58 electrically connected to the RF power detector 56, a multiplier 62 electrically connected to the RF power detector 56 and to the directional coupler 54, and a modulator 60 electrically connected to the multiplier 62. The directional coupler 54 has a control end 52.

Because the majority of the components in the RF transceiver 82 and corresponding components in the prior art RF transceiver 80 have the same characteristics and functionalities, detailed descriptions of the components of the RF transceiver 82 are omitted. Please note that the RF transceiver 82 further comprises the multiplier 62 and the multiplier 62 is connected between the directional coupler 54, the RF power detector 56 and the modulator 60, so the characteristics and the functionalities of the multiplier 62 will be described in the following paragraphs.

When the mobile phone 44 (the mobile phone 46 or 48) is receiving RF signals emitted by the AP 42, a control signal received by the control end 52 of the directional coupler 54 of the mobile phone 44 switches the directional coupler 54 to electrically connect the antenna 50 with the RF power detector 56. After receiving the RF signals transmitted from the antenna 50, the RF power detector 56 detects the power of the RF signals and compares the power with a predetermined power to calculate a power correction factor. The RF power detector 56 then transmits the power correction factor to the multiplier 62. When the mobile phone 44 is about to emit RF signals, the multiplier 62 multiplies the RF signals generated by the modulator 60 and the power correction factor transmitted from the RF power detector 56 to generate corrected-powered RF signals and transmits the corrected-powered RF signals to the antenna 50 to emit the corrected-powered RF signals. Of course, at this moment, the directional coupler 54 is switched to electrically connect the antenna 50 with the multiplier 62. Both the RF signals generated by the modulator 60 and the corrected RF signals conform to IEEE 802.11a and 802.11b standards.

For example, when the RF power detector 56 detects that the power of RF signals received by the antenna 50 is less the predetermined power (the mobile phone 44 is far from the AP 42), the RF power detector 56 then calculates a power correction factor larger than one and transmits the power correction factor to the multiplier 62. When the mobile phone 44 is about to emit RF signals, the modulator 60 generates the RF signals and the multiplier 62 multiplies the RF signals and the power correction factor to generate corrected-powered RF signals and transmits the corrected-powered RF signals to the antenna 50 to transmit the corrected-powered RF signals to the AP 42, guaranteeing that the corrected-powered RF signals received by the AP 42 are clear enough.

On the other hand, as the RF power detector 56 detects that the power of RF signals received by the antenna 50 is greater the predetermined power (the mobile phone 44 is near the AP 42), the RF power detector 56 then calculates a power correction factor smaller than one and transmits the power correction factor to the multiplier 62. When the mobile phone 44 is about to emit RF signals, the modulator 60 generates the RF signals and the multiplier 62 multiplies the RF signals and the power correction factor to generate corrected-powered RF signals and transmits the corrected-powered RF signals to the antenna 50 to transmit the corrected RF signals to the AP 42, saving power consumption when emitting the RF signals of the mobile phone 44.

The power detector 56 needs not detect the power of the RF signals received by the antenna 50 and to generate a corresponding power correction factor every time the power detector 56 receives the RF signals. The mobile phone 44 usually does not move very fast. The mobile phone 44 in a car traveling at a speed of 60 miles per hour moves only 88 feet in one second. The 88 foot displacement is neglectable compared to the distance between the mobile phone 44 and the AP 42. Therefore, the RF power detector 56 of the mobile phone 44 only needs to detect the power of the RF signals received by the antenna 50 of the mobile phone 44 for a short period of time and to generate a corresponding power correction factor periodically. The mobile phone 44 can correct the power of the RF signals generated by the modulator 60 with the corresponding power correction factor during the short period of time.

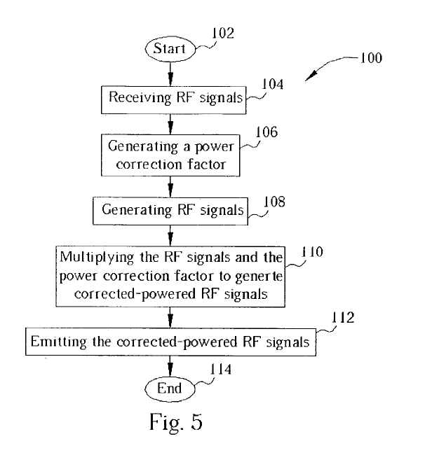

The above-mentioned transceiver 82 is a preferred embodiment applied to a method 100 for controlling the power of RF signals emitted by a wireless communications device according to the present invention. The following paragraphs illustrate steps of the method 100. Please refer to FIG. 5, which is a flow chart illustrating the method 100 for the wireless communications devices 44, 46, and 48 to emit RF signals according to the present invention. The method 100 comprises following steps:

Step 102:Start;

Step 104:

Utilizing the antenna 50 of the mobile phone 44 to receive RF signals;(The RF signals are transmitted by the AP 42.)

Step 106:

Utilizing the RF power detector 56 of the mobile phone 44 to detect the power of the RF signals and generating a corresponding power correction factor according to the power of the RF signals and a predetermined power;(if the power of the RF signals is less than the predetermined power, the RF power detector 56 generates a power correction factor larger than one; On the other hand, if the power of the RF signals is greater than the predetermined power, a power correction factor smaller than one will be generated.)

Step 108:

Utilizing the modulator 60 of the mobile phone 44 to generate RF signals when the mobile phone 44 is about to emit the RF signals;

Step 110:

Utilizing the multiplier 62 of the mobile phone 44 to multiply the RF signals and the power correction factor to generate corrected-powered RF signals;

Step 112:

Utilizing the antenna 50 of the mobile phone 44 to emit the corrected-powered RF signals; (At this moment, the directional coupler 54 is switched to electrically connect the antenna 50 with the multiplier 62.)

Step 114:End.

As mentioned previously, because the distance between the mobile phone 44 and the AP 42 changes slowly, the step 106 of the method 100 can be executed periodically.

In contrast to the prior art, not only can the method for the mobile phones 44, 46, and 48 to emit RF signals prevent damage to the mobile phones 44, 46, and 48 from high-powered RF signals, the method can guarantee that the RF signals the AP 42 receives are clear enough and can reduce the power consumption of the mobile phones 44, 46, and 48.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for controlling the power of radio frequency (RF) signals emitted by a wireless communications device, the wireless communications device having an RF transceiver for emitting and for receiving RF signals, the method comprising:
using the transceiver of the wireless communications device to receive RF signals emitted by a wireless transmission device; and
adjusting the power of RF signals emitted by the transceiver with the wireless communications device according to the RF signals emitted by the wireless transmission device.

2. The method of claim 1, wherein the wireless communications deviceadjusts the power of the RF signals emitted by the transceiver according to the RF signals emitted by the wireless transmission device periodically.

3. The method of claim 1, wherein the transceiver comprises:
an antenna for emitting and for receiving the RF signals;
a directional coupler;
a power detector for generating a power correction factor according to the power of the RF signals;
a modulator for generating the RF signals; and
a multiplier electrically connected between the power detector and the modulator for multiplying the RF signals generated by the modulator and the power correction factor generator by the power detector;
wherein when the transceiver is receiving the RF signals, the directional coupler is switched to connect the antenna to the power detector and the power detector generates a power correction factor according to the power of the RF signals received by the transceiver, and when the transceiver is emitting the RF signals, the directional coupler is switched to connect the antenna to the multiplier, the multiplier multiplies the power correction factor and the RF signals generated by the modulator to generate RF signals of a corrected power, and the antenna emits the RF signals of the corrected power.

4. The method of claim 1 wherein the wireless communications device is a mobile phone.

5. The method of claim 1 wherein the wireless communications device is a personal data assistant (PDA).

6. The method of claim 1 wherein the RF signals emitted by the wireless transmission device conforms to IEEE 802.11a.

7. The method of claim 1 wherein the RF signals emitted by the wireless transmission device conform to IEEE 802.11b.
